(19) United States
(12) Patent Application Publication
(10) Pub. No.: US 2013/0059030 A1
(43) Pub. Date: Mar. 7, 2013

(54) SWEETNER COMPOSITIONS WITH REDUCED BITTER OFF TASTE AND METHODS OF PREPARING

(71) Applicants: Nils Cornelis Adrianus Petrus Sips, Roermond (NL); Ronny Leontina Marcel Vercauteren, Beveren (BE)

(72) Inventors: Nils Cornelis Adrianus Petrus Sips, Roermond (NL); Ronny Leontina Marcel Vercauteren, Beveren (BE)

(73) Assignee: Cargil, Inc, Wayzata (MN)

(21) Appl. No.: 13/696,936

(22) PCT Filed: May 12, 2011
(86) PCT No.: PCT/US11/36307

§ 371 Date: Nov. 20, 2012

Related U.S. Application Data
(60) Provisional application No. 61/395,408, filed on May 12, 2010.

(51) Int. Cl. A23L 1/22; A23G 3/42; A23G 4/10; A23L 1/236; A23L 1/221

(52) U.S. Cl. 426/3; 426/548; 426/658; 426/660

(57) ABSTRACT

This disclosure pertains to a sweetener composition having reduced bitter off taste. Also disclosed are methods of making a sweetener composition of the present invention and food products using the sweetener composition.

### FIELD

The present disclosure is directed to sweetener compositions comprising a milled mixture of a carbohydrate and a high intensity sweetener having a reduced bitter off taste, and methods of making such sweetener compositions.

### BACKGROUND

Natural caloric sugars, such as sucrose, fructose, and glucose, are utilized heavily in beverage, food, pharmaceutical, oral hygiene, and cosmetic industries due to the pleasant taste of such sugars. In particular, sucrose imparts a desirable taste for consumers. Although sucrose provides superior sweetness characteristics, it is caloric. There is a need in the market to provide alternative non-caloric or low-calorie sweeteners, i.e., high intensity sweeteners, with sugar-like taste for consumers with sedentary lifestyles, who are calorie conscious, or who desire to live a healthy lifestyle. However, in general, high intensity sweeteners have associated undesirable tastes to consumers such as delayed sweetness onset, lingering sweet aftertaste, bitter off taste, metallic off taste, astringent off taste, cooling off taste, licorice-like off taste, and the like.

Most high intensity sweeteners exhibit other qualities of taste in addition to sweetness. As an example, saccharin, which is a synthetic sweetener, has been found to exhibit both bitter and metallic off tastes. Cyclamate, another synthetic sweetener, exhibits bitter and salty off tastes. Stevioside and hemandulcin, both natural high intensity sweeteners, also have a bitter off taste. If the taste profile of high intensity sweeteners could be modified to reduce bitter off taste, the type and variety of compositions that may be prepared with that sweetener would be significantly expanded. Accordingly, it would be desirable to reduce the bitter off taste characteristic of many high intensity sweeteners.

### SUMMARY

In one embodiment, the present disclosure relates to a sweetener composition comprising a milled mixture of a particle size of from about 5 microns to about 100 microns of a carbohydrate and a high intensity sweetener, wherein the high intensity sweetener is present in an amount of from about 0.10 wt. % to about 50.0 wt. %, of the milled mixture, and wherein bitter off taste of the milled mixture is reduced compared to a non-milled mixture having a particle size of greater than about 190.0 microns of the carbohydrate and the high intensity sweetener, wherein the high intensity sweetener is present in an amount from about 0.10 wt. % to about 50.0 wt. % of the non-milled mixture. In another aspect, the milled mixture of the sweetener composition has a particle size of from about 20 microns to about 100 microns. Yet in another aspect, the milled mixture of the sweetener composition has a particle size of from about 20 microns to about 50 microns. The high intensity sweetener in another embodiment is present in an amount of from about 0.25 wt. % to about 25.0 wt. % of the milled mixture and of the non-milled mixture.

In another embodiment, the present disclosure relates to a sweetener composition having a milled mixture of a carbohydrate and a high intensity sweetener having at least 60% of the particle size less than 100 microns, where the high intensity sweetener is present in an amount from about 0.10 wt. % to about 50.0 wt. %, and where bitter off taste of the milled mixture is reduced compared to a non-milled mixture of the carbohydrate and the high intensity sweetener having at least 60% of the particle size greater than 500 microns and where the high intensity sweetener is present in an amount from about 0.10 wt. % to about 50.0 wt. %. In another embodiment, the milled mixture of the sweetener composition has greater than 50% of the particle size less than 40 microns. The high intensity sweetener in one aspect is present in an amount from about 0.25% wt. % to about 25.0 wt. %, of the milled mixture and of the non-milled mixture.

A food product can be made using the sweetener composition of the present disclosure. Such food products include chewing gum, lozenges, tablets, oral dispersible powders and capsules, pharmaceuticals, vitamins, dry fillings for confectionery, chocolate and chocolate containing food products, fat-based creams and fillings, and hard and soft candies, mints, gum and cough drops, ice cream, frozen desserts, dry mixes, tabletop, cereals, baked goods, condiments, yogurt, dairy, jams, jellies and preserves, confectionery including chocolate, meat, prepared mixes, icings and glazes, meal replacement bars, savory bars, spreads, fruit fillings, dressings, soups, sauces, baby foods, and pudding.

In another embodiment, a method for preparing a sweetener composition of the present disclosure involves mixing a carbohydrate and a high intensity sweetener to produce a mixture, where the high intensity sweetener is present in an amount from about 0.10 wt. % to about 50.0 wt. %. Such a mixture is milled for about 15 seconds to about 120 seconds to obtain a milled mixture having a particle size of from about 5 microns to about 100 microns, where the bitter off taste of the milled mixture is reduced compared to a non-milled mixture of the carbohydrate and the high intensity sweetener having a particle size of greater than 500 microns and where the high intensity sweetener is present in the same amount as in the milled mixture. In one aspect, the high intensity sweetener is present in an amount from about 0.25 wt. % to about 25.0 wt. % of the milled mixture and of the non-milled mixture. In another embodiment, the milled mixture has a particle size of from about 20 microns to about 100 microns. In yet another embodiment, the milled mixture has a particle size of from about 20 microns to about 50 microns.

In another embodiment, a method for preparing a sweetener composition of the present disclosure involves mixing a carbohydrate and a high intensity sweetener to produce a mixture, where the high intensity sweetener is present in an amount from about 0.10 wt. % to about 50.0 wt. % of the mixture. Such a mixture is milled for about 15 seconds to about 120 seconds to obtain a milled mixture having at least 60% of the particle size less than 100 microns, where the bitter off taste of the milled mixture is reduced compared to a non-milled mixture of the carbohydrate and the high intensity sweetener having at least 60% of the particle size greater than 500 microns and where the high intensity sweetener is present in the same amount as in the milled mixture. In one aspect, the high intensity sweetener is present in an amount from about 0.25 wt. % to about 25.0 wt. %, of the milled mixture and of the non-milled mixture. In another embodiment, the milled mixture has greater than 50% of the particle size less than 40 microns.

The carbohydrate useful in the present invention includes the polyols, erythritol, sorbitol, mannitol, xylitol, and maltitol, dextrose and sucrose. The high intensity sweetener useful in the present invention includes sucralose, acesulfame K, neotame, and rebaudioside A. The rebaudioside A concentration of the present disclosure is from about 40% to about 99.5%, preferably from about 60% to about 99%, more preferably 80% to about 99%, most preferably 95% to about 99%, relative to all steviol glycosides.

### BRIEF DESCRIPTION OF THE DRAWINGS

The present disclosure will become more fully understood from the detailed description given below and the accompanying figures. These figures are given by way of illustration only, and thus are not intended to be limiting of the present disclosure.

FIG. 1 is a graph depicting the density distribution of the particle size of a milled mixture of erythritol and rebaudioside A compared to the particle sizes of erythritol alone and a non-milled mixture of erythritol and rebaudioside A.

FIG. 2 is a graph depicting the cumulative distribution of the particle size of a milled mixture of erythritol and rebaudioside A compared to the particle sizes of erythritol alone and a non-milled mixture of erythritol and rebaudioside A.

### DETAILED DESCRIPTION

### Selected Definitions

Unless otherwise defined, all technical and scientific terms used herein have the same meaning as commonly understood by one of ordinary skill in the art to which this disclosure belongs. Definitions of common terms in chemistry may be found in Richard J. Lewis, Sr. (ed.), Hawley's Condensed Chemical Dictionary, published by John Wiley & Sons, Inc., 14^{th} edition, 2002 (ISBN 0-471-29205-2).

The term “bitter off taste”, as used herein, refers to intensity of bitter taste perceived to be unpleasant, sharp, or disagreeable, on tongue and at the back near the throat.

The term “carbohydrate”, as used herein, refers to aldehyde or ketone compounds substituted with multiple hydroxyl groups, as well as their oligomers and polymers, of the general formula Cₘ(H₂O)ₙ, wherein in and n are independently 3-30. The carbohydrate of the present disclosure can, in addition, be a reduced form of carbohydrate, wherein the carbonyl group (aldehyde or ketone, reducing sugar) has been reduced to a primary or secondary hydroxyl group, such as a polyol which may be a sugar alcohol, polyhydric alcohol, or polyalcohol. The carbohydrates of the present disclosure can, in addition, be substituted or deoxygenated at one or more positions, thereby not falling within the general formula Cₘ(H₂O)ₙ (e.g., fucose). Carbohydrates as used herein encompass unmodified carbohydrates, carbohydrate derivatives, substituted carbohydrates, and modified carbohydrates. Modified carbohydrates means any carbohydrate wherein at least one atom has been added, removed, substituted, or combinations thereof. Thus, carbohydrate derivatives or substituted carbohydrates include substituted and unsubstituted monosaccharides, disaccharides, oligosaccharides, and polysaccharides. The carbohydrate derivatives or substituted carbohydrates optionally can be deoxygenated at any corresponding C-position, and/or substituted with one or more moieties such as hydrogen, halogen, haloalkyl, carboxyl, acyl, acloxy, amino, amido, carboxyl derivatives, alkylamino, dialkylamino, arylamino, alkoxy, aryloxy, nitro, cyano, sulfo, mercapto, imino, sulfonyl, sulfenyl, sulfinyl sulfamoyl, carboalkoxy, carboxamido, phosphonyl, phosphinl, phosphoryl, phosphino, thioester, thioether, oximino, hydrazine, carbamyl, phosphor, phosphonato, or any other viable functional group provided the carbohydrate derivative or substituted carbohydrate functions to improve the taste of a high intensity sweetener.

Non-limiting examples of carbohydrates in embodiments of this disclosure include tagatose, trehalose, galactose, rhamnose, cyclodextrin (e.g., α-cyclodextrin, β-cyclodextrin, and γ-cyclodextrin), polyols (e.g., erythritol, maltitol, mannitol, sorbitol, lactitol, xylitol, isomalt, propylene glycol, glycerol (glycerine), threitol, galactitol, palatinose, reduced isomalto-oligosaccharides, reduced xylo-oligosaccharides, reduced gentio-oligosaccharides, reduced maltose syrup, reduced glucose syrup, or any other carbohydrates capable of being reduced which do not adversely affect the taste of the high intensity sweetener), maltodextrin (including resistant maltodextrins such as Fibersol-2™), dextran, polydextrose, sucrose, dextrose, glucose, ribulose, fructose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, clucono-lactone, abequose, galactosamine, beet oligosaccharides, isomalto-oligosaccharides (isomaltose, isomaltotriose, panose and the like), xylo-oligosaccharides (xylotriose, xylobiose and the like), gentio-oligosaccharides (gentiobiose, gentriotriose, gentiotetraose and the like), sorbose, nigero-oligosaccharides, palatinose oligosaccharides, fucose, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS 55, HFCS 42, or HFCS 90), coupling sugars, soybean oligosaccharides, and glucose syrup. Additionally, the carbohydrates may be in either the D- or L-configuration.

The term “erythritol”, as used herein, refers to a naturally-occurring sugar alcohol that is well known as a sugar substitute and has been approved for use as a sweetener throughout the world. Erythritol is a tetrahydric polyol (butane-1,2,3,4-tetraol) having the structural formula HOCH₂—CHOH—CHOH—CH₂OH (C₄H₁₀O₄). It is also known as meso-erythritol, which is the 2R, 3S isomer. “ErOH”, as used herein, refers to erythritol,

The term “food product”, as used herein, refers to an edible product fit for consumption.

The term “high intensity sweetener” (“HIS”), as used herein, refers to any sweetener found in nature or nature identical which may be in raw, extracted, purified, or any other form, singularly or in combination thereof and characteristically have a sweetness potency greater than sucrose (common table sugar) yet have comparatively less calories. Even if the high intensity sweetener has the same number of calories as sucrose, the usage amount of high intensity sweetener is considerably less than sucrose thereby reducing the total calorie amount. For instance, because high intensity sweeteners are compounds having a sweetness that is many times that of sucrose, much less high intensity sweetener is required to obtain a similar effect as sucrose and energy contribution is therefore negligible. Non-limiting examples of high intensity sweeteners suitable for embodiments of the present invention include rebaudioside A, rebaudioside B, rebaudioside C, rebaudioside D, rebaudioside E, rebaudioside F, dulcoside A, rubusoside, stevia, stevioside, mogroside IV, and mogroside V, Luo Han Gun sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sodium saccharin, cyclamate, aspartame, acesulfame potassium, sucralose, alitame, neotame, neohesperidin dyhydrochalone (NHDC) and combinations thereof. High intensity sweeteners also include modified high intensity sweeteners. Modified high intensity sweeteners include high intensity sweeteners which have been altered naturally. For example, a modified high intensity sweetener includes, but is not limited to, high intensity sweeteners which have been fermented, contacted with enzyme, or isomers of high intensity sweeteners, derivatized or substituted on the high intensity sweetener.

The term “ingredients”, as used herein, refers to any of the compounds that make up the sweetener composition, including erythritol and steviol glycosides.

The term “melting” or “melted”, as used herein, refers to the process of heating the erythritol or mixtures thereof until it changes state from a solid to a liquid. The melting step can be undertaken by any means known in the art of adding heat to the erythritol through heat, steam, microwave, or other means, in an apparatus such as an extruder, oven, double jacketed vessel, or pan.

The term “milled mixture”, as used herein, refers to a mixture of ingredients that has been milled, ground, sieved, crushed, or otherwise processed in order to reduce the particle size of the mixture.

The term “milling” or “milled”, as used herein, refers to milling, grinding, sieving, crushing, or otherwise processing ingredients in order to reduce the particle size of the ingredients.

The term “mixing” or “mixed”, as used herein, refers to the process of dry blending together the ingredients in a container, and manually or mechanically shaking the container for about 5 seconds to about 20 minutes until a homogenous blend is obtained. Mixing may include melting, which results in a melted mixture, that is then allowed to solidify.

The term “non-milled mixture”, as used herein, refers to a mixture of ingredients that has not been milled, ground, sieved, crushed, or otherwise processed.

The term “steviol glycosides” as used herein refers to any of the glycosides of the aglycone steviol (ent-13-hydroxykaur-16-en-19-oic acid) including, but not limited to, stevioside, rebaudioside A, rebaudioside B, rebaudioside C, rebaudioside D, rebaudioside E, rebaudioside F, dulcoside, rebusoside, steviolmonoside, steviolbioside, and 19-O-β glucopyranosol-steviol. “Reb A”, as used herein, refers to rebaudioside A.

The following description of the disclosure is intended to illustrate various embodiments of the disclosure. As such, the specific modifications discussed are not to be construed as limitations on the scope of the disclosure. It will be apparent to one skilled in the art that various equivalents, changes, and modifications may be made without departing from the scope of the disclosure, and it is understood that such equivalent embodiments are to be included herein.

To better understand the present disclosure, it is useful to have at least a general knowledge of certain concepts and terminology related to taste and taste modification. First, taste is often referred to as a taste quality, which is selected from bitter, sweet, sour, salty, and umami. It is possible to have one or more of these taste qualities in the same item. Second, taste modification often involves either an enhancement or synergy, or suppression or masking of a particular taste quality. Taste modification may also involve a change in the duration (or time) and intensity of the taste quality. Thus, in a visual sense, a curve of a taste profile can be shifted forward or backward in time, be lengthened or shortened (duration) and certain peaks can be decreased or increased in height (intensity).

Water-soluble substances, such as components of foods and oral care products, react with taste buds, which are located mainly on the tongue. In general, while the sweet taste is almost always agreeable and the strong sour and salty tastes are tolerable, the bitter, astringent, metallic and irritating tastes are unpleasant, which means that products with such taste profiles are unpalatable. The present disclosure is directed to reducing the bitter off taste present in high intensity sweeteners, in particular, steviol glycosides, and more particularly any rebaudioside, and more particularly rebaudioside A.

Carbohydrates, such as erythritol and cyclodextrins, are known to mask bitter and metallic off tastes from certain high intensity sweeteners. A well-known example is extracts of the native South American plant Stevia rebaudiana. The components of the aqueous extracts of the plant, known as steviol glycosides, are very sweet (180-300 times sweeter than sucrose) but have metallic and bitter off tastes. Previously disclosed formulas in the art use small amounts of erythritol or cyclodextrins to mask the bitter off taste in compositions where the primary sweetness is coming from steviol glycosides. For example, the bitter off taste of steviol glycosides can be reduced by mixing the sweeteners with cyclodextrins.

Several grades of steviol glycosides are available. Better grades having a high rebaudioside A concentration contribute lower bitter off taste levels. For the sweetener compositions of the present disclosure, in one aspect steviol glycosides with rebaudioside A concentration of from about 40 wt. % to 99 wt. % relative to all steviol glycosides is preferred. In another aspect, steviol glycosides with rebaudioside A concentration of about 60 wt. % to 99 wt. % relative to all steviol glycosides is also preferred. In another aspect, steviol glycosides with rebaudioside A concentration of about 80 wt. % to 99.5 wt. % relative to all steviol glycosides is also preferred. In yet another aspect, steviol glycosides with rebaudioside A concentration of about 95 wt. % to 99 wt. % relative to all steviol glycosides is also preferred.

In the present disclosure, milling of a carbohydrate such as erythritol, for example as described in Example 2, with a high intensity sweetener such as rebaudioside A (i.e., a milled mixture) to a particle size from about 5 microns to about 100 microns, surprisingly reduced the bitter off taste associated with the rebaudioside A compared to a non-milled mixture of erythritol and rebaudioside A. While not being bound by any theory, the carbohydrate may form a complex with the high intensity sweetener, which impedes its interaction with the taste buds, thus resulting in a further reduced bitter off taste. Particle size distribution is measured through analysis of angular light-scattering patterns. The laser light diffraction technique used for the determination of particle size distribution is based on the analysis of the diffraction pattern produced when particles are exposed to a beam of monochromatic light. This technique is described in European Pharmacopoeia 5.6 (01/2007:20931), which is incorporated by reference as if fully set forth herein.

Methods to selectively extract one or more of the steviol glycosides, for example, rebaudioside A have been previously disclosed in the art. For example, Japanese Patent 63173531 describes a method of extracting sweet glycosides from the Stevia rebaudiana plant. This procedure isolates a mixture of sweet glycosides. Other techniques include those reported in Japanese Publication Numbers 56121454, 52062300, and 56121453 assigned to Ajinomoto Company, Inc., and U.S. Publication Number 2010-0099857 assigned to Cargill, Incorporated, which is incorporated by reference as if fully set forth herein.

### Sweetner Composition

In one embodiment, the sweetener composition of the present disclosure is a milled mixture having a particle size of from about 5 to about 100 microns of a carbohydrate and a high intensity sweetener where the high intensity sweetener is present in an amount from about 0.10 wt. % to about 50.0 wt. % of the milled mixture (for example, 49.625 grams of a carbohydrate and 0.375 grams of a high intensity sweetener=0.75 wt. % of such high intensity sweetener). Surprisingly, the bitter off taste of the milled mixture is reduced compared to a non-milled mixture having a particle size of greater than about 190 microns of the carbohydrate and the high intensity sweetener, where the high intensity sweetener is present in an amount from about 0.10 wt. % to about 50.0 wt. % of the non-milled mixture. In another aspect, the particle size of the milled mixture is from about 20 to about 100 microns and in yet another aspect from about 20 to 50 microns. The high intensity sweetener, in another aspect, is present from about 0.25 to 25 wt. % of the milled mixture and of the non-milled mixture. For example, a mixture of 49.625 grams of erythritol and 0.375 grams of rebaudioside A (0.75 wt. % rebaudioside A), when milled to a particle size of 33 microns, has a reduced bitter off taste compared to a non-milled mixture of the same wt. % rebaudioside A where the particle size of the non-milled mixture is greater than about 190 microns.

In another embodiment, the sweetener composition of the present disclosure is a milled mixture of a carbohydrate and a high intensity sweetener having at least 60% of the particle size less than 100 microns where the high intensity sweetener is present in an amount from about 0.10 wt. % to about 50.0 wt. % of the milled mixture. Surprisingly, the bitter off taste of the milled mixture is reduced compared to a non-milled mixture of the carbohydrate and the high intensity sweetener having at least 60% of the particle size greater than 500 microns, where the high intensity sweetener is present in an amount from about 0.10 wt. % to about 50.0 wt. % of the non-milled mixture. The particle size of the milled mixture in another aspect has greater than 50% of the particle size less than 40 microns. The high intensity sweetener, in another aspect, is about 0.25 to 25 wt. % of the milled mixture and of the non-milled mixture.

The milled mixtures of the sweetener compositions of the present disclosure comprise other carbohydrates, dextrose, sucrose, and other polyols (sorbitol, mannitol, xylitol, and maltitol), and other high intensity sweeteners, sucralose, acesulfame K, and neotame.

### Methods of Preparing a Sweetener Composition

The present disclosure is further directed to methods of preparing a sweetener composition as described herein. In one embodiment, the present disclosure relates to mixing a carbohydrate and a high intensity sweetener where the high intensity sweetener is present from about 0.10 to 50.0 wt. % of the mixture, and milling the mixture for about 15 to 120 seconds to obtain a milled mixture having a particle size of about 5 to 100 microns and where, surprisingly, the bitter off taste of the milled mixture is reduced compared to a non-milled mixture of a carbohydrate and a high intensity sweetener having a particle size greater than 500 microns where the high intensity sweetener is present in an amount from about 0.10 to 50.0 wt. % of the non-milled mixture. In another aspect, the particle size of the milled mixture is about 20 to 100 microns and in yet another aspect about 20 to 50 microns. The high intensity sweetener, in another aspect, is from about 0.25 to 25 wt. % of the milled mixture and of the non-milled mixture.

In another embodiment, the present disclosure relates to mixing a carbohydrate and a high intensity sweetener where the high intensity sweetener is present in an amount from about 0.10 to 50 wt. % of the mixture, and milling the mixture for about 15 to 120 seconds to obtain a milled mixture having at least 60% of the particle size less than 100 microns and, where, surprisingly, the bitter off taste of the milled mixture is reduced compared to a non-milled mixture having a particle size greater than 500 microns of the carbohydrate and the high intensity sweetener, where the high intensity sweetener is present in an amount from about 0.10 to 50.0 wt. % of the non-milled mixture. In another aspect, the particle size of the milled mixture is about 20 to 100 microns and in yet another aspect about 20 to 50 microns. The high intensity sweetener, in another aspect, is about 0.25 to 25 wt. % of the milled mixture and of the non-milled mixture.

In yet another embodiment, the sweetener composition of the present disclosure is prepared by melting a carbohydrate for about 15 to 30 seconds at a temperature of from about 120 to 200° C. to obtain a carbohydrate melt, adding a high intensity sweetener to the carbohydrate melt to form a mixture, where the high intensity sweetener is present in an amount from about 0.10 to about 50.0 wt. % of the mixture, crystallizing the mixture at room temperature for about 1 to 30 minutes to form a crystallized melt, and milling the crystallized melt for about 15 to 120 seconds to obtain a milled mixture having a particle size of from about 5 to 100 microns. Surprisingly, the bitter off taste of the milled mixture is reduced compared to a non-milled mixture having a particle size of greater than 500 microns of the carbohydrate and the high intensity sweetener, where the high intensity sweetener is present in an amount from about 0.10 to 50.0 wt. % of the non-milled mixture.

In yet another embodiment, the sweetener composition of the present disclosure is prepared by melting erythritol for about 15 to 30 seconds at a temperature of from about 120 to about 200° C. to obtain an erythritol melt adding a steviol glycoside to the erythritol melt to form a mixture, where the steviol glycoside is present in an amount from about 0.10 to 50.0 wt. % of the mixture, crystallizing the mixture at room temperature for about 1 to 30 minutes to form a crystallized melt, and milling the crystallized melt for about 15 to 120 seconds to obtain a milled mixture having at least 60% of the particle size less than 100 microns. Surprisingly, the bitter off taste of the milled mixture is reduced compared to a non-milled mixture having at least 60% of the particle size greater than 500 microns, where the steviol glycosides are present in an amount from about 0.10 to 50.0 wt. % of the non-milled mixture.

The milled mixtures of the sweetener compositions of the present disclosure can be prepared with other carbohydrates, dextrose, sucrose, and other polyols (sorbitol, mannitol, xylitol, and maltitol), and other high intensity sweeteners, sucralose, acesulfame K, and neotame.

### EXAMPLES

The following examples are presented to illustrate the present disclosure and to assist one of ordinary skill in making and using the same. The examples are not intended in any way to otherwise limit the scope of the disclosure.

### Methods

Particle size of the sweetener composition of the present disclosure is measured by laser light diffraction (Sympatec, Model RODOS T4-1). Particle size is expressed as volume mean diameter (VMD).

The mixture of erythritol and Reb A was milled using either an A10 grinder (IKA®, Germany) or SR300 rotor beater mill with a 0.5 mm sieve (Retsch, Germany), as noted in the following examples.

### Example 1

### Sweetener Compositions with Reb A

Three sweetener compositions were made at 0.5 wt. % Reb A (Sample A), 0.75 wt. % Reb A (Sample B), 1.0 wt. % Reb A (Sample C):

| | |
|---|---|
| Sample A | 49.75 grams of erythritol and 0.5 grams of Reb A |
| Sample B | 49.625 grams of erythritol and 0.375 grams of Reb A |
| Sample C | 49.25 grams of erythritol and 0.75 grams of Reb A |

The erythritol is Zerose™ 16954 powder from Cargill, Incorporated (Minneapolis, Minn.). The Reb A is rebiana 09201 powder from Cargill, Incorporated, at a concentration of 98.8 wt. % relative to all steviol glycosides.

Samples A, B, and C were mixed and then milled in an A10 grinder for 0.75 minutes. Sample D (mixture of 49.625 grams of erythritol and 0.375 grams of Reb A) was not milled. The four samples were tasted by six experienced panelists. Each panelist placed about 100 milligram sample on the tip of their tongue and were then asked to rate whether the sample had bitter off taste or not. All six panelists judged Sample D as having bitter off taste. Samples A, B, and C had a reduced bitter off taste and they each tasted good compared to Sample D. Sample B was most preferred, followed by Sample C, and then Sample A.

### Example 2

### Particle Size

Samples E, F, G, and H were prepared by mixing 49.625 grams of erythritol and 0.375 grams of Reb A (0.75 wt. % Reb A) followed by no milling or milling at the various times as indicated in Table 1. Sample K was prepared by milling 49.625 grams of erythritol alone at the time indicated in Table 1 followed by adding 0.375 grams of Reb A. Samples I and J were prepared by mixing 4962.5 grams of erythritol and 37.5 grams of Reb A (0.75% wt. % Reb A) followed by no milling or milling at the various times as indicated in Table 1.

Samples E through K were tasted by five experienced panelists. Each panelist placed about 100 milligram sample on the tip of their tongue and were then asked to rate whether the sample had bitter off taste or not. All five panelists judged Sample E as having bitter off taste. Samples F through J had a reduced bitter off taste and they all tasted good compared to Sample E. Most preferred were Samples F, G, I, and J. Sample K where the erythritol alone was milled had a reduced bitter off taste but not as strikingly noticeable as Samples F, G, I, and J.

TABLE 1

| | | VMD | |
|---|---|---|---|
| Product | Milling | (microns) | X-50 |
| ErOH | Not milled | 590 | 593 |
| Sample E | Not milled | 656 | 657 |
| Sample K | Erythritol alone was milled for 0.5 minute | 87 | 35 |
| | with A10 grinder and then Reb A | | |
| | was added to the milled ErOH | | |
| Sample F | Erythritol and Reb A were mixed and then | 46 | 27 |
| | milled with A10 grinder for | | |
| | 0.5 minute | | |
| Sample G | Erythritol and Reb A were mixed and then | 33 | 19 |
| | milled with A10 grinder for | | |
| | 1.0 minute | | |
| Sample H | Erythritol and Reb A were mixed and then | 218 | 41 |
| | milled with A10 grinder for | | |
| | 3.0 minutes | | |
| Sample I | Erythritol and Reb A were mixed and then | 44 | 27 |
| | milled with SR300 rotor beater | | |
| | mill with a 0.5 mm sieve | | |
| Sample J | Erythritol and Reb A were mixed and then | 40 | 27 |
| | milled with SR300 rotor beater | | |
| | mill with a 0.5 mm sieve | | |

In addition to taste, the particle size of each sample was determined using laser light diffraction. A surprising aspect of the new sweetener composition is that the bitter off taste associated with high intensity sweeteners, such as steviol glycosides, in particular rebaudioside A, was reduced when the erythritol was milled for 0.5 minute (sample F) to a particle size of 46 microns and 1.0 minute (sample G) to a particle size of 33 microns. Milling the erythritol and Reb A for 3.0 minutes caused the milled mixture to agglomerate, presumably because of heat generated from milling, which accounted for the larger particle size of 218 microns. X-50 represents 50% of the particles in each sample is less than or equal to the X-50 value. For example, 50% of the particles in sample K is less than or equal to 35 microns; 50% of the particles in samples F, I, and J is less than or equal to 27 microns; 50% of the particles in sample G is less than or equal to 19 microns; 50% of the particles in sample H is less than or equal to 41 microns.

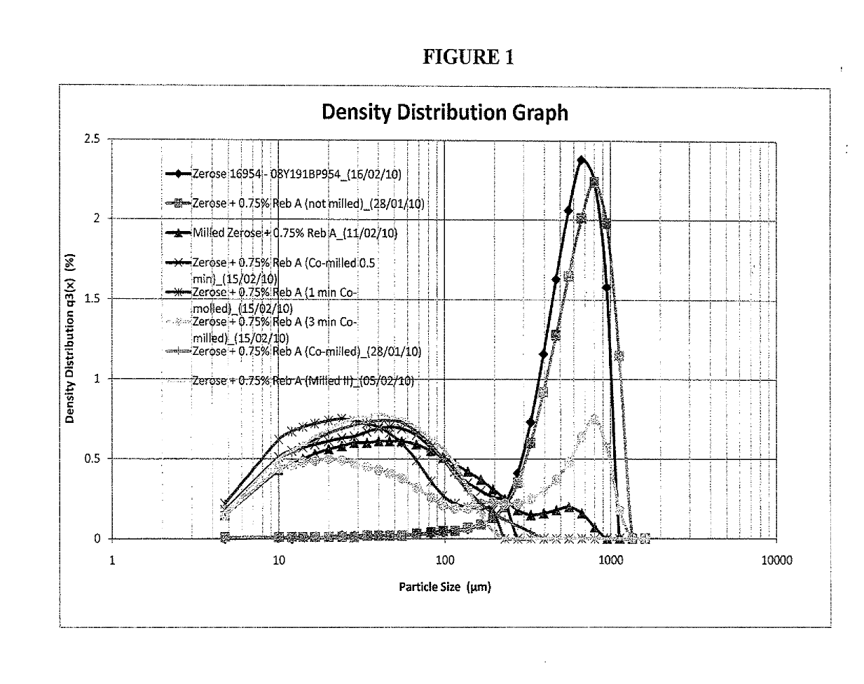

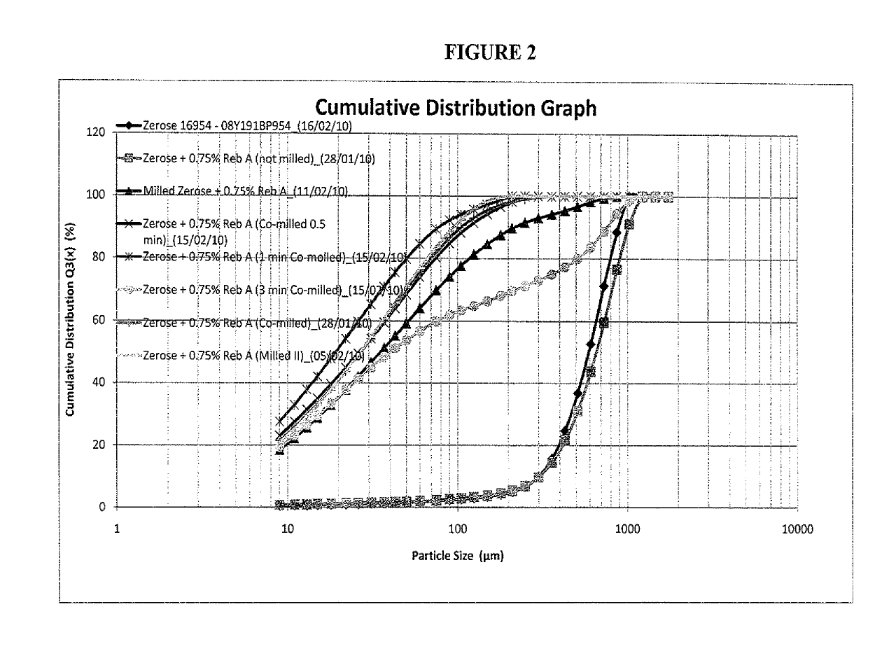

The particle size distribution of the samples in Example 2 is depicted in FIGS. 1 and 2, FIG. 1 illustrates the density distribution of particle size of each of the samples is from about 5 microns to about 100 microns. FIG. 2 illustrates at least 60% of the particle size of each of the samples is less than 100 microns.

### Example 3

### Additional Sweetener Compositions

In Table 2, five sweetener compositions were made with the polyols, erythritol, maltitol, sorbitol, isomalt, mannitol, and xylitol, each with 1.0 wt. % Reb A. Two sweetener compositions were made with the carbohydrates, dextrose and sucrose, each with 1.0 wt. % Reb A. In addition, 10 wt. % of a milled mixture of erythritol and 10 wt. % Reb A was diluted with 90 wt. % sorbitol to give a 90 wt. %/10 wt. % sorbitol/erythritol with 1.0 wt. % Reb A.

The erythritol is Zerose™ 16954 powder from Cargill, Incorporated (Minneapolis, Minn.). The Reb A is rebiana 09201 powder from Cargill, Incorporated, at a concentration of 98.8 wt. % relative to all steviol glycosides.

Samples 22 to 28 were mixed and then milled in an A10 grinder for 0.75 minutes. The nine samples were tasted by four experienced panelists. Each panelist placed about 100 milligram sample on the tip of their tongue and were then asked to rate whether the sample had bitter off taste or not. All four panelists judged Samples 23, 24, 26, 29, and 30 as having a reduced bitter off taste and they all tasted good. Samples 22, 27, and 28 also had a reduced bitter off taste but not as strikingly reduced compared to Samples 23, 24, 26, 29, and 30.

Sample 29 shows that milling of a higher concentration of a high intensity sweetener produces a sweetener composition with reduced bitter off taste.

In addition to taste, the particle size of each sample was determined using laser light diffraction. The results are shown in Table 2A.

TABLE 2

| Sample | | | Taste | | | Taste | |
|---|---|---|---|---|---|---|---|
| nr. | Sample | Processing | A | N.A | Processing | A | N.A. |
| 22 | Maltitol + | non-milled | 1 | 3 | Milled | 2 | 2 |
| | 1% Reb A | | | | | | |
| 23 | Sorbitol + | non-milled | 2 | 2 | Milled | 4 | 0 |
| | 1% Reb A | | | | | | |
| 24 | Dextrose + | non-milled | 3 | 1 | Milled | 4 | 0 |
| | 1% Reb A | | | | | | |
| 25 | Isomalt + | non-milled | 0 | 4 | Milled | 0 | 4 |
| | 1% Reb A | | | | | | |
| 26 | Mannitol + | non-milled | 3 | 1 | Milled | 4 | 0 |
| | 1% Reb A | | | | | | |
| 27 | Xylitol + | non-milled | 3 | 1 | Milled | 3 | 1 |
| | 1% Reb A | | | | | | |
| 28 | Sucrose + | non-milled | 0 | 4 | Milled | 3 | 1 |
| | 1% Reb A | | | | | | |
| 29 | 90/10 Sorbitol/ | non-milled | 4 | 0 | | | |
| | (ErOH + 10% | | | | | | |
| | Reb A) | | | | | | |
| 30 | ErOH + | | | | Milled | 4 | 0 |
| | 1% Reb A | | | | | | |

A = acceptable
N.A. = Not acceptable

TABLE 2A

| | | as is (A) | | | | | | milled (B) | | | |
|---|---|---|---|---|---|---|---|---|---|---|---|
| N^{o} | Sample | X₅₀ | | | VMD | | | X₅₀ | | VMD | |
| 22 | Maltitol + 1% Reb A | 179.9 | 183.6 | | 188.3 | 191.1 | | 26.2 | 25.9 | 42.5 | 42.3 |
| 23 | Sorbitol + 1% Rebiana | 206.2 | 189.2 | 193.0 | 218.2 | 204.5 | 208.2 | 56.8 | 56.1 | 75.9 | 75.3 |
| 24 | Dextrose + Reb A | 392.5 | 391.7 | 425.3 | 417.1 | 433.7 | 433.1 | 66.7 | 66.8 | 89.2 | 93.2 |
| 25 | Isomalt + 1% Reb A | 788.3 | 714.5 | | 754.9 | 672.7 | | 41.2 | 40.4 | 63.0 | 62.3 |
| 26 | Mannitol + 1% Reb A | 37.6 | 40.4 | | 47.0 | 49.6 | | 19.2 | | 27.6 | |
| 27 | Xylitol + 1% Reb A | 437.2 | 455.9 | | 430.7 | 450.0 | | 22.2 | 20.1 | 43.7 | 32.6 |
| 28 | Sucrose + 1% Reb A | 465.1 | 505.7 | | 452.7 | 491.7 | | 19.6 | 20.1 | 28.8 | 28.5 |
| 29 | 90/10 Sorbitol/(ErOH + 10% Reb A) | 191.0 | 181.4 | | 207.7 | 196.4 | | | | | |

### Example 4

### Additional Sweetener Compositions

Sample 33 was made where a milled mixture of erythritol and 25 wt. % Reb A was diluted with erythritol to give a mixture of erythritol and 1 wt. % Reb A. Sample 34 was made where a milled mixture of erythritol and 50 wt. % Reb A was diluted with erythritol to give a mixture of erythritol and 1% Reb A. This example shows that dilution of higher concentrated Reb A milled with erythritol can be used to dilute with unmilled erythritol to obtain a final concentration of 1% Reb A in erythritol with a better taste (i.e., reduced bitter off taste) than an unmilled mixture of 1% Reb A in erythritol. The amount of ingredient or mixture thereof to mill can be reduced. In addition, using a higher concentration of a milled mixture of erythritol and Reb A can be used in food products, i.e., one does not need to add so much erythritol to get the same concentration of Reb A in food products. Further, milling lower volumes of a mixture of erythritol and Reb A with high concentrations of Reb A allows for cost savings in that large volumes to mill is not needed. The milled mixture of erythritol and Reb A can then be diluted by mixing, for example, with other ingredients such as erythritol, sorbitol, maltodextrin, etc.

The erythritol is Zerose™ 16954 powder from Cargill, Incorporated (Minneapolis, Minn.). The Reb A is rebiana 09201 powder from Cargill, Incorporated, at a concentration of 98.8 wt. % relative to all steviol glycosides.

The erythritol with 25 wt. % Reb A (Sample 31) and the erythritol with 50 wt. % Reb A (Sample 32) were mixed and then milled in an A10 grinder for 0.75 minutes, and used as Samples 33 and 34 for dilution with erythritol to give a mixture of erythritol and 1 wt. % Reb A. The two samples were tasted by three experienced panelists. Each panelist placed about 100 milligram sample on the tip of their tongue and were then asked to rate whether the sample had bitter off taste or not. All three panelists jdged Sample 33 as having a reduced bitter off taste and tasted good. One of the three panelists judged Sample 34 as having a reduced bitter off taste and tasted good.

TABLE 3

| Sample | | | Total Weight | ErOH | Rebiana |
|---|---|---|---|---|---|
| nr. | Sample | Processing | (g) | (g) | (g) |
| 31 | ErOH + 25% Reb A | milled | 25 | 18.75 | 6.25 |
| 32 | ErOH + 50% Reb A | milled | 25 | 12.5 | 12.5 |

| | | | Total | | | Taste |
|---|---|---|---|---|---|---|
| Sample | | | Weight | ErOH | | Accept- |
| nr. | Sample | Processing | (g) | (g) | | ance |
| | | | | | ErOH + | |
| | | | | | 25% | |
| | | | | | Reb A | |
| | | | | | (g) | |
| 33 | ErOH + 1% | non-milled | 50 | 48 | 2 | 3/3 |
| | Reb A by | | | | | |
| | diluting 25% | | | | | |
| | Reb A/ErOH | | | | | |
| | | | | | ErOH + | |
| | | | | | 50% | |
| | | | | | Reb A | |
| | | | | | (g) | |
| 34 | ErOH + 1% | non-milled | 50 | 49 | 1 | 1/3 |
| | Reb A by | | | | | |
| | diluting 50% | | | | | |
| | Reb A/ErOH | | | | | |

### Example 5

### Melt

49.625 grams of erythritol were placed in a glass bottle and set in an oil bath (IKA Model HBR4 Digital) in 140° C. for 20 minutes. 0.375 grams of Reb A was added to the bottle when the erythritol was melted and mixed gently. The bottle was placed in the oil bath for another 5 minutes. The melted sample was poured into two round 7-cm aluminum pans and left at room temperature to crystallize for about 5 minutes. The crystallized melt sample was then milled in an A10 grinder for one minute to a particle size of about 30 microns to about 50 microns.

The crystallized melt sample and sample D in Example 1 were tasted by two experienced panelists. Each panelist placed about 100 milligram sample on the tip of their tongue and were then asked to rate whether the sample had bitter off taste or not. The crystallized melt sample had a reduced bitter off taste and tasted good compared to Sample D.

### Example 6

### Chewing Gum

A chewing gum formulation was made as shown in Table 4 on a commercial basis (%). The term “commercial basis”, as used herein, refers to the compounds in the formulation that are used ‘as is’ (i.e., without the addition of water, for example) so that the compounds are used in the state they are commercially available when purchased from a supplier.

The erythritol is Zerose™ 16954 powder from Cargill, Incorporated (Minneapolis, Minn.). The Reb A is rebiana 09201 powder from Cargill, Incorporated, at a concentration of 98.8 wt. % relative to all steviol glycosides.

The chewing gum was made by preheating a Z-blade apparatus (Winkworth Model MZ 4/2) to 50° C. The gum base (Cafosa Gum, S.A.U., Barcelona, Spain) was heated in a microwave for 3 to 5 minutes and then placed in the Z-blade and mixed at speed 4 rpm in a forward direction for 5 minutes. Half of the sweetener composition (i.e., milled mixture of erythritol and Reb A) was added to the gum base in the Z-blade and mixed for 5 minutes at 4 rpm. The entire syrup was then added in the blender and mixed for 5 minutes. The other half of the sweetener composition and powder flavor, if used, were next added and mixed again for 5 minutes. Glycerine was then added and mixed for 5 minutes. Liquid flavor was lastly added and the entire contents in the blender mixed not more than 3 to 5 minutes.

TABLE 4

| | Liquid | Powder | Powder | |
|---|---|---|---|---|
| | flavor F18 | flavor F16 | flavor F17 | No flavor |
| Gum base | 35.0% | 35.0% | 35.0% | 35.0% |
| Milled mixture of ErOH | 53.0% | 52.63% | 52.5% | 53.0% |
| and 0.75% Reb A | | | | |
| Maltitol syrup | 9.8% | 10.0% | 10.0% | 10.0% |
| Glycerine | 2.0% | 2.0% | 2.0% | 2.0% |
| Natural flavor | 0.2% | 0.38% | 0.5% | 0.0% |
| Total | 100.0% | 100.0% | 100.0% | 100.0% |

The four chewing gums were tasted by six experienced panelists and compared to gum products that contained non-milled mixture of ErOH and 0.75% Reb A. The sample containing flavor F16 was the most preferred, F17 was more preferred, and F18 and no flavors were equivalent in taste. The gum sample with flavor F16 gave a less burst of sweetness, which in turn could linger somewhat longer in the mouth. In general, even the gum sample with no added flavor was sweet and without the bitter off taste.

### Example 7

### High Intensity Sweeteners

Each of the high intensity sweeteners, aspartame (DG6 4881), sucralose (Eurochem 800 017), sodium saccharine (ADG 11096A6), neo-hesperidin (Cargill 1111125), monatin (Cargill), and glycyrrhizin (Cargill 1006576), was mixed with Zerose™ 16954 erythritol powder (Cargill) according to Table 5, and milled in an A10 grinder for 0.75 minute, or not milled. The amount of each high intensity sweetener was calculated to obtain a concentration of 1 wt. %.

The non-milled mixture and milled mixture products were tasted by six experienced panelists. Each panelist placed about 100 milligram sample on the tip of their tongue and were then asked to rate which sample had a taste improvement (i.e., the samples of a non-milled mixture versus a milled mixture of a particular high intensity sweetener were compared with each other). The results of the taste test are shown in the last column of Table 5.

In addition to taste, the particle size of each sample was determined using laser light diffraction. The results are shown in Table 5A.

TABLE 5

| Sample | | % | ErOH | HIS | |
|---|---|---|---|---|---|
| nr. | Intense sweetener | to add | (g) | (g) | improvement |
| 43 | Aspartame | 1.5 | 49.250 | 0.750 | 3/6 |
| 44 | Sucralose | 0.5 | 49.750 | 0.250 | 5/6 |
| 45 | Na-Saccharine | 1 | 49.500 | 0.500 | 2/6 |
| 46 | Neohesperidine | 1.2 | 49.400 | 0.600 | 3/6 |
| 47 | Monatin | 0.21 | 49.895 | 0.105 | 3/6 |
| 48 | Acesulfame K | 1.5 | 49.250 | 0.750 | 4/6 |
| 49 | Sodium Cyclamate | 7.5 | 46.250 | 3.750 | 2/6 |
| 51 | Neotame | 0.03 | 49.985 | 0.015 | 4/6 |
| 52 | Talin MD90 | 0.13 | 49.935 | 0.065 | 3/6 |
| | (Thaumatin) | | | | |
| 53 | Glycyrrhizin | 1.33 | 49.335 | 0.665 | 3/6 |

TABLE 5A

| | | as is (A) | | | | milled (B) | | | |
|---|---|---|---|---|---|---|---|---|---|
| N^{o} | Sample | X₅₀ | | VMD | | X₅₀ | | VMD | |
| 44 | ErOH + | 434.2 | 519.3 | 451.0 | 512.6 | 21.3 | 21.4 | 40.2 | 40.1 |
| | 1% | | | | | | | | |
| | Sucralose | | | | | | | | |
| 51 | ErOH + | 490.1 | | 502.8 | | 20.8 | 19.6 | 36.2 | 33.4 |
| | 1% | | | | | | | | |
| | Neotame | | | | | | | | |

### Example 8

### Sweetener Compositions with Reb A

Sweetener compositions with varying concentrations of Reb A relative to all steviol glycosides were made: 0.75 wt. % Reb A 40 (Cargill, Reb A concentration of 42%, Sample A), 0.75 wt. % Reb A 60 (Cargill, Reb A concentration of 64.2%, Sample B), and 0.75 wt. % Reb A 80 (Cargill, Reb A concentration 79.2%, Sample C). Samples A, B, C contained 49.625 grams of Zerose™ erythritol powder 16954 from Cargill, and 0.375 grams of Reb A 40, Reb A 60, Reb A 80 respectively.

TABLE 6

| Sample | | Total Weight | ErOH | Rebiana |
|---|---|---|---|---|
| nr. | Sample | (g) | (g) | (g) |
| A | ErOH + 0.75% Reb A | 50 | 49.625 | 0.375 |
| | (with Reb A-40) | | | |
| B | ErOH + 0.75% Reb A | 50 | 49.625 | 0.375 |
| | (with Reb A-60) | | | |
| C | ErOH + 0.75% Reb A | 50 | 49.625 | 0.375 |
| | (with Reb A-80) | | | |
| A1 | ErOH + 0.75% Reb A | 50 | 49.625 | 0.375 |
| | (with Reb A-40) | | | |
| A2 | ErOH + 0.75% Reb A | 50 | 49.625 | 0.375 |
| | (with Reb A-60) | | | |
| A3 | ErOH + 0.75% Reb A | 50 | 49.625 | 0.375 |
| | (with Reb A-80) | | | |

Half the weight of samples A, B, and C were each milled in an A10 grinder (IRA) for 0.75 minutes to obtain samples A1 (Reb A-40), A2 (Reb A-60), and A3 (Reb A-80). The samples were tasted by four experienced panelists. Each panelist placed about 100 milligram sample on the tip of their tongue and were then asked to rate whether the sample had bitter off taste or not. Three out of four panelists judged sample Al as having less bitter off taste compared to sample A. Three out of four panelists judged sample A2 as having less bitter off taste compared to sample B. All four panelists judged sample A3 as having less bitter off taste compared to sample C. The panelists rated the milled mixture sample of Reb A 80 and erythritol as having the least bitter off taste, though Reb A 40 and Reb A 60 also had an improved less bitter off taste. Similar results were obtained with the milled mixture samples of 1 wt. % Reb A each at 40, 60, and 80.

### Example 9

### Sweetener Compositions Containing Coconut Fat

As shown in Table 7, 7.0 grams (g) coconut fat (Cargill Refined Oils Europe, CN25) and 21 g cocoa mass (Gerkens Cocoa, IVC01) (“chocolate mimic”) were put in a glass beaker, which was placed in a water bath at 50° C. As shown in Table 8, 21.9 g of erythritol was milled for 0.75 minute in an A10 grinder and then 0.1 g Reb A 97 (97.8% Reb A, 1.9% other glycosides and 1.1% water) was blended with the milled erythritol (sample designated “blended”); 21.9 g of erythritol and 0.1 Reb A 97 were mixed and then milled in an A10 grinder for 0.75 minute (sample designated as “comilled”); and 0.1 gram Reb A 97, and 0.05 gram p-cyclodextrin (CAVAMAX W7 Food from Wacker) were mixed and then milled in an A10 grinder for 0.75 minute and then 21.85 grams erythritol were added to the milled mixture, which was again milled for 0.75 minute in an A10 grinder (sample designated as “β-cyclo comill”). The amount of each of these samples as shown in Table 8 was added to the glass beaker containing the chocolate mimic and mixed until a homogeneous mixture was obtained (about 10 minutes).

TABLE 7

| 50 g Dark chocolate mimic | (%) | (g) |
|---|---|---|
| Coconut fat | 14 | 7 |
| Cocoa mass | 42 | 21 |
| sweetener | 44 | 22 |

TABLE 8

| | blended | comilled | β-cyclo comill |
|---|---|---|---|
| ErOH | 21.9 | 21.9 | 21.85 |
| Reb A | 0.1 | 0.1 | 0.1 |
| β-cyclo | | | 0.05 |

| | | as is (A) | | | |
|---|---|---|---|---|---|
| N^{o} | Sample | X₅₀ | | VMD | |
| β-cyclo | CAVAMAX W7 Food | 80.2 | 78.8 | 119.7 | 122.9 |

The products were judged by 3 experienced panelists after 24 hours residence time in an oven at 50° C. All three panelists judged the “comilled” product as having a less bitter taste and no licorice effect compared to the “blended” product. The “β-cyclo comill” had even a better taste compared to the “comilled” and “blended” products because no bitterness was perceived.

### Example 10

### Lozenges

99.25% (w/w) Zerose™ 16954 erythritol powder was milled with Reb A 97 (0.75% w/w) for 0.75 minute using an IKA MF-10 mill (Hammer mill, impact grinding) to obtain a milled mixture. This milled mixture was mixed, using a Hobart mixer, with a 10% aqueous gelatin 150 bloom PS30 (Rousselot) solution in a ratio 88.7/11.3 (w/w) until a homogeneous texture was obtained (about 10 minutes). The obtained dough is than kneeded manually for another minute. Subsequently, the dough is rolled out and the lozenges are stamped out. The lozenges are dried for another 3 days in an oven at 45° C. to give the samples A.

99.25% (w/w) Zerose™ 16954 erythritol powder was milled using an IKA MF-10 mill, and subsequently blended with 0.75% (w/w) Reb A 97. This mixture was mixed, using a Hobart mixer, with a 10% aqueous gelatin 150 bloom PS30 (Rousselot) solution in a ratio 89.3/10.7 (w/w) until a homogeneous texture was obtained (about 10 minutes). The obtained dough is than kneeded manually for another minute. Subsequently the dough is rolled out and the lozenges are stamped out. The lozenges are dried for another 3 days in an oven at 45° C. to give the samples B.

99.25% (w/w) Zerose™ 16954 erythritol powder was blended with 0.75% (w/w) Reb A 97. This mixture was mixed, using a Hobart mixer, with a 10% aqueous gelatin 150 bloom PS30 (Rousselot) solution until a homogeneous texture was obtained (about 10 minutes). The obtained dough is than kneeded manually for another minute. Subsequently the dough is rolled out and the lozenges are stamped out. The lozenges are dried for another 3 days in an oven at 45° C. to give the samples C.

The products were judged by six experienced panelists. All six panelists judged sample A as the best one (less licorice, less bitter). The second best was sample B. The worst was sample C.

The particle sizes of the three samples were measured:

TABLE 9

| | VMD | |
|---|---|---|
| Milling | (microns) | X-50 |
| Sample A | 69.1 | 48.8 |
| Sample B | 67.4 | 41./8 |
| Sample C | 656.2 | 657.0 |

A surprising aspect of the new sweetener composition is that the bitter off taste associated with high intensity sweeteners, such as steviol glycosides, in particular rebaudioside A, was reduced when the erythritol was milled, in this example, for 0.75 minute.

As stated above, the foregoing is merely intended to illustrate various embodiments of the present disclosure. The specific modifications discussed above are not to be construed as limitations on the scope of the disclosure. It will be apparent to one skilled in the art that various equivalents, changes, and modifications may be made without departing from the scope of the disclosure, and it is understood that such equivalent embodiments are to be included herein. All references cited herein are incorporated by reference as if fully set forth herein.

1. A sweetener composition comprising a milled mixture of a particle size of from about 5 microns to about 100 microns of a carbohydrate and a high intensity sweetener, wherein the high intensity sweetener is present in an amount of from about 0.10 wt. %, to about 50.0 wt. %, of the milled mixture, and wherein bitter off taste of the milled mixture is reduced compared to a non-milled mixture having a particle size of greater than about 190 microns of the carbohydrate and the high intensity sweetener, wherein the high intensity sweetener is present in an amount from about 0.10 wt. % to about 50.0 wt. % of the non-milled mixture.

2. The sweetener composition of claim 1, wherein the milled mixture has a particle size of from about 20 microns to about 100 microns.

3. The sweetener composition of claim 1, wherein the milled mixture has a particle size of from about 20 microns to about 50 microns.

4. A sweetener composition comprising a milled mixture of a carbohydrate and a high intensity sweetener having at least 60% of the particle size less than 100 microns, wherein the high intensity sweetener is present in an amount from about 0.10 wt. % to about 50.0 wt. %, of the milled mixture, and wherein bitter off taste of the milled mixture is reduced compared to a non-milled mixture of the carbohydrate and the high intensity sweetener having at least 60% of the particle size greater than 500 microns, wherein the high intensity sweetener is present in an amount from about 0.10 wt. % to about 50.0 wt. %, preferably from about 0.25% wt. % to about 25.0 wt. %, of the non-milled mixture.

5. The sweetener composition of claim 4, wherein the milled mixture has greater than 50% of the particle size less than 40 microns.

6. The sweetener composition according to claim 4, wherein the carbohydrate is a dextrose, a sucrose, or a polyol selected from the group consisting of erythritol, sorbitol, mannitol, xylitol, and maltitol.

7. The sweetener composition according to claim 4, wherein the high intensity sweetener is selected from the group consisting of sucralose, acesulfame K, neolame, and rebaudioside A.

8. The sweetener composition of claim 7, wherein the high intensity sweetener is rebaudioside A and the rebaudioside A concentration is from about 40% to about 99%, relative to all steviol glycosides.

9. A food product comprising a sweetener composition according to claim 4, wherein the food product is selected from the group consisting of chewing gum, lozenges, tablets, oral dispersible powders and capsules, pharmaceuticals, vitamins, dry fillings for confectionery, chocolate and chocolate containing food products, fat-based creams and fillings, and hard and soft candies, mints, gum and cough drops, ice cream, frozen desserts, dry mixes, tabletop, cereals, baked goods, condiments, yogurt, dairy, jams, jellies and preserves, confectionery including chocolate, meat, prepared mixes, icings and glazes, meal replacement bars, savory bars, spreads, fruit fillings, dressings, soups, sauces, baby foods, and pudding.

10. A method for preparing a sweetener composition comprising the steps of:
a. mixing a carbohydrate and a high intensity sweetener to produce a mixture, wherein the high intensity sweetener is present in an amount from about 0.10 wt. % to about 50.0 wt. %, of the mixture; and
b. milling the mixture of step a. for about 15 seconds to about 120 seconds to obtain a milled mixture having a particle size of from about 5 microns to about 100 microns,
thereby reducing bitter off taste of the milled mixture of step b. compared to a non-milled mixture having a particle size of greater than 500 microns of the carbohydrate and the high intensity sweetener, wherein the high intensity sweetener is present in an amount from about 0.10 wt. % to about 50.0 wt. %, of the non-milled mixture.

11. The method of claim 10, wherein the mixture has a particle size of from about 20 microns to about 100 microns.

12. The method of claim 10, wherein the mixture has a particle size of from about 20 microns to about 50 microns.

13. (canceled)

14. (canceled)

15. The method according to claim 10, wherein the carbohydrate is a dextrose, a sucrose, or a polyol selected from the group consisting of erythritol, sorbitol, mannitol, xylitol, and maltitol.

16. The method according to claim 10, wherein the high intensity sweetener is selected from the group consisting of sucralose, acesulfame K, neotame, and rebaudioside A.

17. The method of claim 16, wherein the high intensity sweetener is rebaudioside A and the rebaudioside A concentration is from about 40% to about 99.5%, relative to all steviol glycosides.

18. The sweetener composition according to claim 1, wherein the carbohydrate is a dextrose, a sucrose, or a polyol selected from the group consisting of erythritol, sorbitol, mannitol, xylitol, and maltitol.

19. The sweetener composition according to claim 1, wherein the high intensity sweetener is selected from the group consisting of sucralose, acesulfame K, neotame, and rebaudioside A.

20. The sweetener composition of claim 19, wherein the high intensity sweetener is rebaudioside A and the rebaudioside A concentration is from about 40% to about 99%, relative to all steviol glycosides.

21. A food product comprising a sweetener composition according to claim 1, wherein the food product is selected from the group consisting of chewing gum, lozenges, tablets, oral dispersible powders and capsules, pharmaceuticals, vitamins, dry fillings for confectionery, chocolate and chocolate containing food products, fat-based creams and fillings, and hard and soft candies, mints, gum and cough drops, ice cream, frozen desserts, dry mixes, tabletop, cereals, baked goods, condiments, yogurt, dairy, jams, jellies and preserves, confectionery including chocolate, meat, prepared mixes, icings and glazes, meal replacement bars, savory bars, spreads, fruit fillings, dressings, soups, sauces, baby foods, and pudding.

22. The sweetener composition according to claim 1, wherein the high intensity sweetener is present in an amount of from about 0.25 wt. % to about 25.0 wt. %, of the milled mixture, and wherein bitter off taste of the milled mixture is reduced compared to a non-milled mixture, wherein the high intensity sweetener is present in an amount from about 0.25 wt. % to about 25.0 wt. %, of the non-milled mixture.
